(19) United States
(12) Patent Application Publication
(10) Pub. No.: US 2019/0314866 A1
(43) Pub. Date: Oct. 17, 2019

(54) Device and Method for Hydrodynamic Surface Cleaning Based on Micro-Hydropercussion Effect

(71) Applicants: Mishail N. BOLDYREV, Moscow (RU); Roman E. PASHKOV, Tolyatti (RU); Ilya L. REMENEV, Moscow (RU)

(72) Inventors: Mishail N. BOLDYREV, Moscow (RU); Roman E. PASHKOV, Tolyatti (RU); Ilya L. REMENEV, Moscow (RU)

(21) Appl. No.: 16/452,446

(22) Filed: Jun. 25, 2019

Related U.S. Application Data
(63) Continuation of application No. PCT/RU2017/000846, filed on Nov. 10, 2017.

(30) Foreign Application Priority Data
Dec. 26, 2016 (RU) 2016151279

(51) Int. Cl. B08B 3/02; B08B 5/02; B24C 5/04

(52) U.S. Cl. CPC B08B 3/02; B08B 2203/02; B24C 5/04; B08B 5/02

(57) ABSTRACT

A nozzle for hydrodynamic cleaning has a form form of a flow passage with a profile formed by an inlet confuser, a resonance chamber and a diffuser arranged in axial alignment and interconnected in series. The confuser and the diffuser are connected via the resonance chamber, which has a form of a flow-over lip. The ratio of the cross-sectional area at the confuser outlet and the cross-sectional area at the opening of the resonance chamber forming the flow-over lip is 1.5 to 10.0. The preferred ratio of the resonance chamber surface area and the cross-sectional area at the opening of the resonance chamber is 0.05 to 40.0. The diffuser can comprise means for additional supply of fluid, gas or particulates. Impact is performed through a fluid jet flowing from a nozzle of the working member in a fluid or a gaseous medium.

### RELATED APPLICATIONS

This Application is a Continuation application of International Application PCT/RU2017/000846, filed on Nov. 10, 2017, which in turn claims priority to Russian Patent Applications RU2016151279, filed Dec. 26, 2016, both of which are incorporated herein by reference in their entirety.

### FIELD OF THE INVENTION

The invention relates to technologies for cleaning of surfaces, items and components of natural and industrial impurities in water/in other fluids or in an air/gaseous medium.

### BACKGROUND OF THE INVENTION

The cleaning methods are currently limited to mechanical (hydro mechanical), hydraulic, hydro abrasive, air abrasive and air shot-blasting treatment using high-pressure equipment. These cleaning methods are well-known and are extensively used in industrial and household devices.

The hydraulic surface cleaning methods are most efficient, however they require dedicated high-value equipment to be used to generate high pressure (600 to 2500 bar), dedicated maintenance and qualification of personnel, safety to be complied with when performing operations.

The hydro mechanical methods of cleaning (mechanical brush with water feed) are most cost-efficient and accessible, however they cannot ensure high performance of operations, this applies especially to removal of natural sub-aqueous deposits (algae and mollusks).

The hydro abrasive methods of cleaning fall in between the above in relation to performance and complexity of operations, however they require additional use of abrasives.

Air abrasive and air-shot blasting methods of cleaning are only suitable for open-air operations (in docks), that being said, the air-short blasting methods of cleaning show average performance and also require additional consumption of materials.

In some instances, mechanical jet (hydro abrasive, air abrasive, air shot-blasting) methods of cleaning cannot be used.

Having high performance, the hydro cavitation methods of cleaning do not have many of disadvantages.

A device in the form of a cavitation nozzle to discharge high-speed fluid jet with cavitation bubbles. A nozzle comprising a feed chamber having an input, an output and a middle section with a permanent cross-sectional area. The outlet has a conical shape with an angle of approximately 65° to 90°, preferably 75° to 85° and optimally about 80°. The outlet opening has a diameter of 1.2 mm to 4.0 mm. As the fluid passes through the opening under super-atmospheric pressure, cavitation bubbles are formed. In the preferred embodiment of the invention, the middle section of the feed chamber has a diameter of 12 mm to 50 mm. In another preferred embodiment, the nozzle has several outlet openings. In another preferred embodiment, the device operates with an option of resting on a treated surface, which results in a high speed of the fluid jet to impact the surface at an angle of approximately 30° to 60° (U.S. Pat. No. 4,342,425, Aug. 3, 1982).

A nozzle attachment for hydro cavitation cleaning, comprising a body with a nozzle passage to pass the working fluid, a disk deflector installed at the channel outlet and having a sharp edge on the end face to activate the cavitation process. The nozzle passage is shaped as a contraction annual slit, which is formed by a cylinder-shaped external surface and a conical internal surface, wherein the second sharp edge is performed on the end face of the body on the side of the disk deflector to intensify the cavitation process, both edges are formed by the top parts of the collar steps arranged in axial alignment, while the deflector is attached to the body end by a detachable connection. The invention downsizes the device dimensions through a higher hydro cavitation impact (RU 2113289, Jun. 20, 1998),

A hydro cavitation device comprising a body, which embeds an inlet, an inlet cylinder-shaped passage, at least two chambers and a diffuser arranged in axial alignment and interconnected in series downstream of the fluid and communicated with one another. The diameter and the length of the intermediate cylinder-shaped passage are designed to comply with predefined ratios. At least one intermediate cylinder-shaped passage is lain between the two chambers. The diffuser is connected directly to the nearest chamber and forms a sharp edge between the adjacent surfaces of the diffuser and the nearest chamber (RT 2236915, Sep. 27, 2004).

A nozzle for underwater cleaning, comprising: a body with a central flow passage, formed by an inlet confuser, and expansion chamber and an outlet diffuser. Passages are made in the body of the diffuser at an angle to the flow passage longitudinal axis, those passages connected to the expansion chamber cavity. The nozzle has an extra diffuser. A body of the extra diffuser can be installed on the body of the nozzle with an option of longitudinal motion of the diffuser along the nozzle followed by anchoring in a required position. It is practical to provide the nozzle with an ultrasonic vibration source, which can be adjoined to the expansion chamber on side of the inlet confuser. It is practical to make the ultrasonic vibration source as a cylinder-shaped middle body with a central passage, with an internal surface made as a comb (RU 2222463, Jan. 27, 2004).

A device for underwater cleaning by cavitating and pressured fluid jet, wherein the cavitator comprising: a flow passage with a profile formed by an inlet confuser, a cylinder-shaped passage and an outlet diffuser, arranged in axial alignment and connected with one another. The cavitator is housed in the cylinder-shaped passage of the well screen. In the cylinder-shaped passage of the cavitator, a fluid flow straightener is mounted as a cellular body comprised of equal-sized longitudinal plates, which length l is defined₂ by a ratio 2<l2<2,6dₖ, where dₖ, is the inlet diameter of the cylinder-shaped passage inlet. The plates make up cells of equal area and the number of plates is divisible by even numbers. Distance l₁ from the cylinder-shaped passage head to the fluid flow straightener is defined by a ratio 2,8<l₁<3dₖ. Distance l₃ from the cylinder-shaped passage tail to the fluid flow straightener is defined by a ratio 2,4<l₃<2,6dₖ. The inlet diameter of the outlet diffuser d_{D} is larger than the outlet diameter of the passage. The device provides for increase of the cavitation degree and the length of the working jet by eliminating perturbing factors of the fluid flow and by improving its hydrodynamic performance (RU 2258130, Aug. 10, 2005).

A device represented as a cavitation nozzle to generate a high-speed fluid jet, comprising a nozzle body and nozzle disk embedded in the nozzle body and deepened. The nozzle body has an inlet and an outlet opening. The contact surfaces are impacted by compression pressure. The nozzle body is located around the nozzle disk so as to create compression pressure on the contact surfaces of the nozzle disk (U.S. Pat. No. 7,243,865, Jul. 17, 2007).

A device, in which the cavitation nozzle is provided with an extra body, which encapsulates it and forms an extra passage between the external surface of the body and the internal surface of the extra body, arranged in axial alignment with a central flow passage, and connected to the pressured fluid source, the body has openings that connect the extra passage with the outlet diffuser of the central flow passage (WO 7243865, Jul. 17, 2007),

A hydrodynamic method for underwater cleaning of surfaces and a device to perform such cleaning, wherein a surface is treated by a fluid jet flowing under pressure from the device (cavitation actuator) and creating an active volume around the fluid as a cavern. The extended cavern volume is provided by adjusting the jet pressure and gradual change of the distance between the cavitation actuator and the surface to be cleaned. This distance is set as an operating position of the actuator, when the hydrodynamic pressure in the fluid jet cavity reaches its maximum perturbation. The device comprising: a body, an inlet confuser, and expansion chamber, an outlet diffuser, and is performed with an enabled option to adjust the volume of the expansion chamber, in which cavitation actuates (RU 2376193, Dec. 20, 2009).

A cavitator comprising: a body with an internal end-to-end cavity, comprising: an inlet opening with a cylinder-shaped section and a confuser with a toe-in angle α. The cavitator also comprising: an expansion chamber, a side opening and an outlet opening performed as a diffuser with a toe-in angle β. The internal end-to-end cavity of the cavitator, comprising: transition sections, made with a ribbed internal side surface, and a cylinder-shaped section of the inlet opening located at the inlet of the cavitator, with transition to the referred to confuser; the outlet of the confuser is connected via one of the transition sections with the inlet of the expansion chamber, made with an internal side surface in stepped configuration. The middle section of the expansion chamber is made with the maximum diameter in relation to other sections made in stepped configuration, and is connected with η side openings. Herein the expansion chamber outlet is connected via another transition section with a diffuser inlet made with an internal side surface in stepped configuration (RU 2568467, Nov. 20, 2015).

A cavitation nozzle, in which the first and the second compression loop is connected in series with a jet turbulence section. A de Laval loop is located between the loops. The passage cross-sectional diameters of the nozzle elements, and the cleaning fluid jets actuating cavitation are made using quadratic relation of the working look of the nozzle to ensure the maximum pressure of the cleaning fluid jet (RU 2575033, Feb. 10, 2016).

The closest analog of the present invention is a method of underwater hydrodynamic cleaning of ships hulls and a device to perform such cleaning, which gist is that cavitation in a cleaning area is ensured by simultaneous impact of the treated surface by a fluid jet and acoustic radiation. This radiation is generated by an acoustic generator. The latter will he housed inside the working member. The generator operates from the dynamic pressure energy of the jet. A water jet is applied to the treated surface at an angle of no more than 45°. The cleaning nozzle has a flow passage and a profile. The latter is formed by an inlet confuser, a cylinder-shaped and an outlet section arranged in axial alignment and interconnected in series. The cylinder-shaped section is made as a resonance chamber, and the outlet section as a limiter. The chamber diameter is larger than the outlet opening of the confuser and the inlet opening of the outlet section. The chamber walls form its inlet and outlet nozzle in configuration with the outlet opening of the confuser and the inlet opening of the acoustic source. The chamber and the nozzles form an acoustic generator. The difference between the diameters of the nozzles is no more than 0.3 of the chamber length. The outlet opening diameter of the acoustic source is no less than 0.04 of the wave length of the main frequency in the chamber. The confuser has a taper angle of 10 to 20° (RU 2123957, Dec. 27, 1998). The main disadvantage of this device is that its operation is limited to the water medium. Formulated differently, the device is intended for underwater cleaning; use of the device in the air medium degrades its performance to zero (owing to specific issues related to distribution of the cavitation impact in a hydrodynamic jet).

### SUMMARY OF THE INVENTION

An object of the invention is to create a device, which performs efficient hydrodynamic cleaning of surfaces in both fluid and gaseous media with minimum energy demands.

The technical result of the invention is high-performance, stable cavitation, sufficient for practical tasks at lower pressure and cost to clean the surfaces of industrial and natural impurities both in a fluid medium and in an air medium.

The technical result by the use of the nozzle, comprising a flow passage with a profile formed by an inlet confuser, a resonance chamber and a diffuser arranged in axial alignment and interconnected in series, wherein the resonance chamber has a form of a flow-over lip, the ratio of the cross-sectional area at the confuser outlet and the cross-sectional area at the opening of the resonance chamber forming the flow-over lip is 1.5 to 10, and by impacting the surface to be cleaned by means of a fluid jet under pressure, flowing from a nozzle of the working member, characterized in that treatment is performed by means of the nozzle according to claim 1.

The essence of the invention is to generate and maintain a phenomenon of micro-hydro percussion (indirect hydraulic shock) in the cleaning area by impacting the surface to be cleaned by dynamic pressure and cavitation of the fluid jet, such impact generating resonance vibration of the fluid jet and substantially improving the cleaning effect. Cavitation in the fluid jet occurs, as the water flows through a nozzle of predefined construction. Herein, the fluid jet resonance vibrations occur at a predefined angle and distance between the device and the surface to be cleaned.

The distinctive and conceptual property of the micro-hydro percussion provided by the device is the stable impact of the effect in the air medium, while other devices of this kind operate stably in the water medium, i.e., in fluid. Besides, the claimed device also provides for efficient hydrodynamic cleaning process in the water medium.

The distinction of the nozzle construction is that it comprises a resonance chamber, which has a form of a flow-over lip, wherein the ratio of the cross-sectional area at the confuser outlet and 10. When using the device, the so-called hydrodynamic jet expansion area is formed, which ensures the formation of stable fluid jet flow cavitation in the air, while other devices of this kind form stable cavitation in the water medium: “water-in-water” flow.

Cavitation phenomena occur at various water pressure values and at various passage section areas, which define the flow rate, necessary for the cavitation jet of the required intensity to be formed. Notably, insufficiently large pressure will result in either an absence of cavitation or its fast degradation in the jet. Insufficiently large passage section diameter will result in cavitation “implosion” inside the passage section, which as a rule will result in fast wear and tear of the nozzle.

Following the conducted studies, optimal passage diameter to passage length combinations have been received, as reflected in the ratio of the cross-sectional area at the confuser outlet and the cross-sectional area at the opening of the resonance chamber forming the flow-over lip is 1.5 to 10, As a result, stable and sufficiently intensive cavitation inside the flowing out water jet occurs at a sufficiently low pressure in the range of 180 to 200 atmosphere.

As commonly known, more complex and expensive pumping units are required to use higher pressure. The known similar devices stably operate under the following conditions:
either at a water pressure ranging from 600 atmospheres and above
or the cavitation jet occurring inside the fluid volume (fluid-in-fluid flow).

In the claimed invention, the stably operating cavitation jet enables the required effect at a pressure of approximately 200 atmospheres in the air (water-in-air flow). Notably, at a predefined pressure and a water flow rate (given the pumping unit parameters), the cavitation inside the flowing out water jet remains stable and intensive at the entire distance from the nozzle to the surface to be cleaned. In other instances, cavitation either “degrades” or “implodes” in the jet, before it ever reaches the surface to be cleaned, or the cavitation intensity is insufficient for the cleaning effect. Without pressure and water flow rate increase, the claimed invention allows for reaching stable and sufficient cavitation for practical tasks at lower pressure and flow rate values.

### BRIEF DESCRIPTION OF DRAWINGS

FIG. 1 depicts a cross-section of a nozzle for hydrodynamic cleaning; and

FIG. 2 is a schematic illustration of operation of a device.

### DETAILED DESCRIPTION OF THE PREFERRED EMBODIMENTS

Design Description of Nozzle

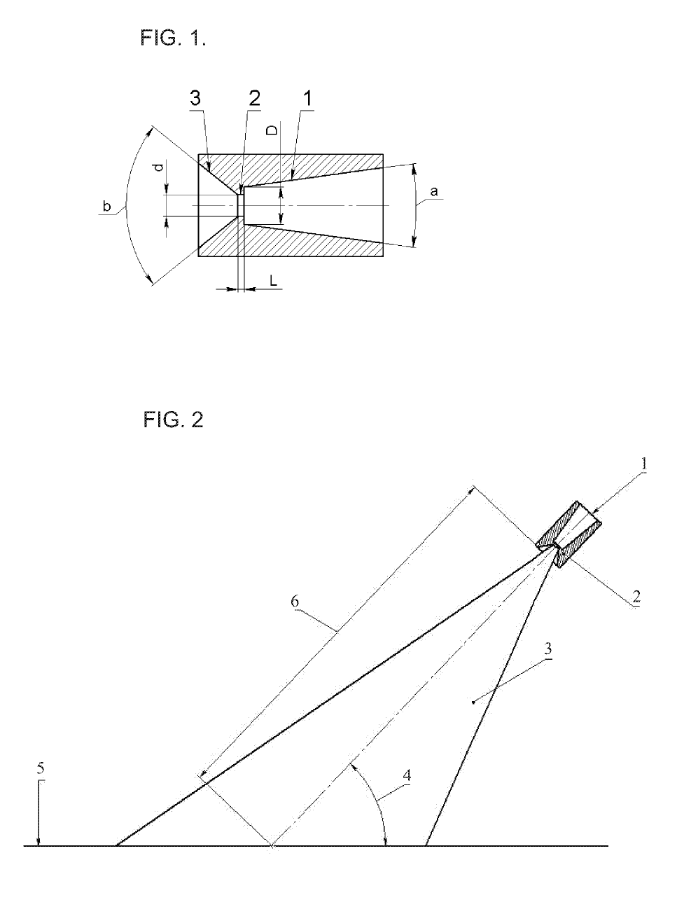

FIG. 1 depicts a nozzle for hydrodynamic cleaning, wherein 1 depicts an inlet confuser, 2 depicts a resonance chamber, which has a form of a flow-over lip, 3 depicts a diffuser, D refers to the outlet diameter of the confuser, d refers to the diameter of the cross-sectional opening of the resonance chamber, L refers to the resonance chamber length, a and b refer to the taper angles of the confuser and the diffuser. FIG. 2 depicts e device operation circuit, wherein supplied fluid (1), nozzle of the working member (2), fluid jet (3), slope angle (4) to the surface to be cleaned (5), distance from the device to the surface to be cleaned (6).

A nozzle for hydrodynamic cleaning is in the form of a flow passage with a profile formed by an inlet confuser (1), a resonance chamber (2) and a diffuser (3) arranged in axial alignment and interconnected in series. The resonance chamber has a form of a flow-over lip, wherein the ratio of the cross-sectional area at the confuser (D) outlet and the cross-sectional area at the opening of the resonance chamber (d) forming the flow-over lip is 1.5 to 10.

The ratio of the resonance chamber surface area and the cross-sectional area at the opening of the resonance chamber is preferably 0.05 to 40.0.

The diffuser can comprise means for additional supply of fluid, gas or particulates.

The confuser has most preferably a conical shape with a taper angle of 10°-20° (a)

The diffuser has most preferably a conical shape with a taper angle of 15°-70° (b).

These parameters have been obtained out of the hundreds of experiments followed by their subsequent processing to find and describe the consistency patterns.

As a result, the nozzle is composed of a water jet acceleration area, a water cavitation area and a cavitating jet expansion area. The acceleration area accelerates the water jet, its primary function is to straighten and stabilize the water flow by its limited acceleration before entering the cavitation area. The cavitation area is formed by a resonance chamber having a form of a flow-over lip. The formed bubbles shall on the one hand be intensive enough to have sufficient cleaning effect when impacting the surface, however, they are not to be too intensive not to “lock” the acceleration passage, as the “degrading” jet manifests itself as a simple flow of bubbling foam, which intensively decelerates resulting in the formed bubbles being imploded immediately after exiting the acceleration passage, so a cleaning effect will not be achieved.

The expansion area has the function to stabilize the cavitating jet. When exiting the acceleration passage, an expansion area is being formed with a low-pressure area respectively, which prevent “degrading” of jet; formulated differently, thanks to the outlet cone, a divergent cone is formed instead of a narrow high-pressure water flow. As a result, a sufficiently wide spot is generated, as the cavitating jet impact the surface to be cleaned. The micro-hydro percussion in this spot generates backward impact through the water jet and transfers vibration to the working tool; based on the vibration behavior, the intensity of impact to the surface to be cleaned can be evaluated. The micro-hydro percussion impact as a backward impact to evaluate the cavitation intensity is a differentiator. While other cavitation intensity evaluation methods are based on measuring the surface destruction rate, the claimed method is based on measuring the jet perturbation caused by micro-hydro percussion in the form of backward impact.

Cleaning Method Implementation

To perform hydrodynamic cleaning in the fluid or gaseous medium, the surface to be cleaned is to be impacted by a fluid jet under pressure. Fluid (1) is supplied, fluid is flowing from a nozzle of the working member (2). The fluid jet (3) most preferably flows at an angle of 5° to 90° (4) to the cleaned surface (5), most preferably at a distance of 5 to 1000 mm from the device to the surface to be cleaned (6). Cleaning efficiency can be evaluated by vibration intensity of the nozzle. A combination of the jet angle and the distance from the nozzle to the surface to be cleaned is defined by intensity of the micro-hydro percussion impact, which is perceived on side of the nozzle as sufficiently intensive vibration that can be personally perceived as “more intensive/less intensive”, if the device is operated manually, or by a dedicated strain-gauge sensor, if the device is mounted on a holding tool. Consequently, by changing the angle and the distance, the maximum cleaning intensity can be defined by the maximum micro-hydro percussion.

### EMBODIMENT 1

### Cleaning of Tubes from Industrial Impurities (Concrete),

Problem: Cleaning the drill rods of the drilling mud (concrete blend with additives). The distinction of the impurity is that the drilling rod having the form of a tube is entirely, from end to end, clogged by the drilling mud, wherein the blend is of very high quality, therefore it is difficult to clean the resulting mass. Cleaning with the application of the micro-hydro percussion impact is performed in the following sequence:
a device using the micro-hydro percussion impact is mounted onto a dedicated holding tool, representing a thin steel 5 m long tube,
the dedicated holding tool is connected to a high-pressure hose, section 0.25″, connected to a pumping unit,
the pumping unit with parameters 500 atmospheres, 40 L/min, activated by a self-contained diesel plant and connected to an industrial water pipeline,
when evaluating efficiency of various methods, the first cleaning is performed by using a nozzle in form of a simple high-pressure atomizer used in car wash service, etc. As consequence, the tube is cleaned extremely slowly, and the evaluation has to be terminated because of a failure to make any further progress, and the internal deposits of hardened concrete cannot be cleaned.
subsequent cleaning is performed using a manual device with a nozzle according to the claimed invention, with a ratio of the cross-sectional area at the confuser and the cross-sectional area at the opening of the resonance chamber being 2.76; with a ratio of the resonance chamber surface area and the cross-sectional area at the opening of the resonance chamber being 2.11; a taper angle of the confuser being 14°28′, a taper angle of the diffuser being 34. The complete cleaning of the part takes 20 minutes, wherein the internal deposits of hardened concrete are removed completely. The comparison results are registered by photo and video recording.

### EMBODIMENT 2

### Cleaning of the Internal Surface of the Tube from Industrial Impurities (Chemical Scaling)

Problem: Cleaning of the internal surface of a heat exchanger of impurity by scaling of bitumen (chemical production). As the heat exchanger operates, the internal surface of the tubes with circulating bitumen is exposed to scaling due to high temperatures, this decreases the capacity of the heat exchanger. To solve the problem, the equipment is shut down at regular intervals and is partially dismantled to perform its cleaning. The distinction of the problem solution is that extremely tight cleaning terms are set, as the downtime of the plant results in severe losses. Therefore, performance of the cleaning equipment is critical. The internal surface of the heat exchangers are usually cleaned by ultra-high pressure apparatus (1000 atmosphere) using a water jet and milling cutters, wherein water jet cleaning takes substantial time due to low performance and incomplete cleaning of the surface. The remaining mechanical impurities are removed by the milling cutters, which causes wear and tear of the heat exchangers surfaces increasing the probability of their failure before their scheduled service life, which demands extremely high-value repairs. Cleaning with the application of the micro-hydro percussion impact is performed in the following sequence:
the heat exchanger to be cleaned was partially dismantled and located onto a surface, which ensures easy access to the butt-ends (cleaning area),
a device according to the claimed invention, with a ratio of the cross-sectional area at the confuser and the cross-sectional area at the opening of the resonance chamber being 8.97; with a ratio of the resonance chamber surface area and the cross-sectional area at the opening of the resonance chamber being 3.78; a taper angle of the confuser being 20°, a taper angle of the diffuser being 36°, using the micro-hydro percussion impact, mounted onto a dedicated holding tool represented by a section of a flexible 5 m long plastic pipeline, section 0.25″, to enable movement of the heat exchanger tube cleaning device inside the heat exchanger tubes considering line bends and curved sections,
the flexible plastic pipeline is connected to the high-pressure main hose, section 0.25″, connected to a pumping unit,
the pumping unit is represented by a mobile pump station with the pump parameters 1000 atmospheres-20 l/min, and supplied with a self-contained diesel engine, and a water treatment system (water heating and filtration unit), connected to an industrial water supply system,
when evaluating efficiency of the method, the tube is cleaned by using a nozzle in form of a simple ultra-high pressure atomizer followed by an attachment inform of a hydro mechanic milling cutter,
subsequent cleaning of the second tube is performed with a nozzle, which uses the micro-hydro percussion impact, no hydro mechanic milling cutter is used, the micro-hydro percussion impact is created at a distance of 100 to 200 mm from the surface,
cleaning during several minutes using a conventional nozzle resulted in incomplete cleaning, the nozzle is to be replaced by a hydro mechanic milling cutter, which does not ensure the complete cleaning of the tube,
cleaning using a nozzle with a micro-hydro percussion impact resulted in complete cleaning of the tube, which took less than 1 minute, no hydro mechanic milling cutter was required,
the cleaning results are evaluated by the water discharge from the opposite end of the cleaned tube: when cleaning using a conventional nozzle, the supplied water starts running out backwards (the nozzle bears against insurmountable clogging), and the use of the hydro mechanic milling cutter shows insufficient water discharge, which means that clogging is surmounted, but cleaning is incomplete; the use of the nozzle with the hydro-micro percussion impact according to the claimed invention shows fast surmounting of clogging and substantial water discharge from the tube, which means its complete cleaning. The comparison results are registered by photo and video recording.

### EMBODIMENT 3

### Cleaning of a Component

Problem: Cleaning of a form work joint of an impurity from hardened concrete. When using the form work, concrete fills the joint and hardens. Subsequent use of the joint after dismantling of the form work is not possible without cleaning the joint. Surface cleaning using conventional high-pressure apparatus takes substantial time, complete cleaning of the component is not possible. Cleaning using mechanical methods causes damage to the zinc-plated surface of the component, followed by its corrosion and its state of disrepair. Cleaning with the application of the micro-hydro percussion impact is performed in the following sequence:
the component to be cleaned is fixed and reliably fastened to avoid displacement, in a location not vulnerable to water splash,
device according to the claimed invention, with a ratio of the cross-sectional area at the confuser and the cross-sectional area at the opening of the resonance chamber being 5.49; with a ratio of the resonance chamber surface area and the cross-sectional area at the opening of the resonance chamber being 2.69; with a taper angle of the diffuser being 20°, a taper angle of the diffuser being 35, with a distance of the device of 100 to 200 mm from the surface at an angle of 45 to 80° to the surface to he cleaned; the device is mounted onto a manual holder tool represented by tap having a form of a pistol grip, and an extension with a device fastener,
the manual holder tool is connected to the pumping unit by a high-pressure hose, section 0.5″,
the pumping unit is represented by a mobile pump station with the pump parameters 170 atmospheres-70 l/min, and supplied with a self-contained diesel engine, and a water tank, volume 1000 l,
when evaluating efficiency of the method, the first cleaning is performed by a manual device having a nozzle as a conventional high-pressure atomizer used in car wash service, etc.
subsequent cleaning is performed using a manual device with a nozzle using the micro-hydro percussion impact at a distance of 100 to 200 mm from the surface,
the pumping unit operation is evaluated using a manometer and water flow measuring in a measuring container (filling of a large 20 l laboratory bottle is measured with the use of the nozzle),
results of the component cleaning after several minutes using a conventional nozzle show that the component is only partially cleaned, wherein the internal deposits of hardened concrete preventing operation of the component are cannot be cleaned,
results of the cleaning using a nozzle, which uses the micro-hydro percussion impact, show the complete cleaning time of 1 minute, wherein internal deposits of hardened concrete are completely removed, and the mobility of the component is reinstated.

The comparison results are registered by photo and video recording.

Thus, use of the claimed nozzle, which uses the micro-hydro percussion impact provides for efficient cleaning of surfaces of industrial and natural impurities at lower pressure values and at low costs, including cleaning in the air medium.

What is claimed is:

1. A nozzle for hydrodynamic cleaning comprising:
a flow passage with a profile formed by an inlet confuser, a resonance chamber and a diffuser arranged in axial alignment and interconnected in series, the confuser and the diffuser being connected via the resonance chamber, the resonance chamber being in a form of a flow-over lip, wherein a ratio of a cross-sectional area at an outlet of the confuser and a cross-sectional area at an opening of the resonance chamber forming the flow-over lip ranges from 1.5 to 10.0.

2. The nozzle for hydrodynamic cleaning according to claim 1, wherein a ratio of a surface area of the resonance chamber and a cross-sectional area at the opening of the resonance chamber ranges from 0.05 to 40.0.

3. The nozzle for hydrodynamic cleaning according to claim 1, the diffuser comprises means for additionally supplying fluid, gas or particulates.

4. The nozzle for hydrodynamic cleaning according to claim 1, wherein the confuser has a conical shape.

5. The nozzle for hydrodynamic cleaning according to claim 4, wherein the confuser has a taper angle of 10°-20°.

6. The nozzle for hydrodynamic cleaning according to claim 1, wherein the diffuser has a conical shape.

7. The nozzle for hydrodynamic cleaning according to claim 6, wherein the diffuser has a taper angle of 15°-70°.

8. A method of hydrodynamic cleaning comprising:
impacting a surface to be cleaned by a fluid jet under pressure, the fluid jet flowing from a nozzle of a working member in a fluid or gaseous medium, the impacting being performed by means of the nozzle for hydrodynamic cleaning comprising:
a flow passage with a profile formed by an inlet confuser, a resonance chamber and a diffuser arranged in axial alignment and interconnected in series, the confuser and the diffuser being connected via the resonance chamber, the resonance chamber being in a form of a flow-over lip, wherein a ratio of a cross-sectional area at an outlet of the confuser and a cross-sectional area at an opening of the resonance chamber forming the flow-over lip ranges from 1.5 to 10.0.

9. The method of hydrodynamic cleaning according to claim 8, wherein the fluid jet flows at an angle of 5° to 90° to the surface to be cleaned.

10. The method of hydrodynamic cleaning according to claim 8, wherein the fluid jet flows at a distance of 5 to 1000 mm to the surface to be cleaned.

11. A method according to claim 8, further comprising evaluating cleaning efficiency by a vibration intensity of the nozzle.
